(19) United States
(12) Patent Application Publication
(10) Pub. No.: US 2010/0068570 A1
(43) Pub. Date: Mar. 18, 2010

(54) FUEL CELL SYSTEM

(76) Inventor: Yasuki Otake, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/596,035

(22) PCT Filed: Apr. 10, 2008
(86) PCT No.: PCT/IB08/00859

§ 371 Date: Oct. 15, 2009

(30) Foreign Application Priority Data
Apr. 16, 2007 (JP) 2007-106947

(51) Int. Cl. H01M 8/04; H01M 8/24

(52) U.S. Cl. 429/13; 429/23

(57) ABSTRACT

A fuel cell system is provided which efficiently performs a scavenging process for a fuel cell stack (10) constituted of a plurality of fuel cells (40) each of which generates electric power using reaction gas supplied. When the power generation of the fuel cell stack (10) is stopped or when the power generation of the fuel stack (10) is not being performed, a scavenging process is performed in which the reaction gas, as a scavenging gas, is circulated from the gas passage portions (44, 46) to the outlet manifold (62, 68). During the scavenging process, the area via which the scavenging gas is discharged from each gas passage portion (44, 46) to the outlet manifold (62, 68) is limited, and the area to be limited is sequentially switched from one to another.

### BACKGROUND OF THE INVENTION

1. Field of the Invention

The invention relates to a fuel cell system, and in particular to a fuel cell system in which a scavenging process for discharging the moisture remaining in the fuel cell system is performed.

2. Description of the Related Art

A fuel cell stack is constituted of a plurality of fuel cells stacked on top on each other. Each fuel cell also has a stack structure constituted of several thin components. More specifically, each fuel cell is constituted of an MEA (Membrane Electrode Assembly) consisting of an electrolyte membrane and electrodes provided on both sides of the electrolyte membrane and separators sandwiching the MEA from both sides.

In such a fuel cell, in order to enable efficient power generation, it is necessary to keep the electrolyte membrane highly moistened. For this reason, the inside of each fuel cell is always moistened using the water produced from the power generation of the fuel cell and the moisture carried into the fuel cell by the reaction gas. When the power generation operation is stopped, the moisture contained in the gas in the fuel cell is condensed and dews are formed. Therefore, when the fuel cell system is used in a cold district, or the like, the dews are frozen and then clog up the reaction gas passages, which may result in deterioration of the startability of the fuel cell system.

In order to solve this issue, for example, Japanese Patent Application Publication No. 2006-04904 (JP-A-2006-04904) describes a fuel cell system that performs a scavenging process for removing the moisture remaining in each fuel cell. According to this fuel cell system, more specifically, when a power generation stop request has been issued, a large amount of scavenging gas is circulated through the fuel cells, so that the moisture stagnating in each fuel cell is discharged to the outside together with the scavenging gas.

According the fuel cell system described above, however, because a large amount of gas needs to be supplied, at a high pressure, to each fuel cell during the scavenging process, a compressor having a large capacity needs to be provided, and therefore the electric power stored in the battery may be consumed excessively.

### SUMMARY OF THE INVENTION

The invention provides a fuel cell system capable of performing an efficient scavenging process in a fuel cell stack.

The first aspect of the invention relates to a fuel cell system having: a fuel cell stack constituted of a plurality of fuel cells stacked on top of each other and adapted to generate electric power using a reaction gas supplied, each of the fuel cells having a gas passage portion through which the reaction gas flows and an outlet manifold to which the reaction gas is discharged from the gas passage portion; and scavenging means for circulating a scavenging gas from the gas passage portion to the outlet manifold when power generation of the fuel cell stack is stopped or when power generation of the fuel cell stack is not being performed. The scavenging means limits an area via which the scavenging gas is discharged from the gas passage portion.

According to the fuel cell system described above, the area via which the scavenging gas is discharged from the gas passage portion to the outlet manifold is limited during the scavenging process. As the outlet of the gas passage portion is thus reduced, the rate of the gas flow in the vicinity of the outlet of the gas passage portion increases, and therefore the moisture remaining in the gas passage portion can be effectively discharged to the outside.

The above-described fuel cell system may be such that: the outlet manifold includes a plurality of outlet manifolds separated from each other and corresponding to respective regions of the gas passage portion; opening-degree adjusting means for adjusting an opening degree is provided in at least one of the outlet manifolds; and the scavenging means controls the opening-degree adjusting means so as to narrow down the at least one of the outlet manifolds.

According to this structure, because the outlet manifold includes a plurality of outlet manifolds, at least one of said manifolds can be narrowed down. When a scavenging process is performed in the fuel cell system thus structured, at least one of the outlet manifolds is narrowed down, so that the area to which the scavenging gas is discharged can be effectively limited.

Further, the above-described fuel cell system may be such that: the outlet manifold includes a plurality of outlet manifolds separated from each other and corresponding to respective regions of the gas passage portion; outlet opening-degree adjusting means for adjusting the opening-degree of the outlet manifolds are provided in the outlet manifolds, respectively; and the scavenging means controls the outlet opening-degree adjusting means so as to narrow down at least one of the outlet manifolds.

According to this structure, because the outlet manifold includes a plurality of outlet manifolds, at least one of said manifolds can be narrowed down. When a scavenging process is performed in the fuel cell system thus structured, at least one of the outlet manifolds is narrowed down, so that the area to which the scavenging gas is discharged can be effectively limited.

Further, the above-described fuel cell system may be such that the scavenging means sequentially switches the outlet manifold to be narrowed down by the outlet opening-degree adjusting means from one to another.

According to this structure, during the scavenging process, the gas outlet of the gas passage portion is switched from one to another by switching the outlet manifold to be narrowed down, and therefore the moisture remaining in the respective regions of the gas passage portion can be effectively discharged to the outside.

The second aspect of the invention relates to the fuel cell system according to the first aspect of the invention wherein: each of the fuel cells has a plurality of inlet manifolds connected to an upstream end of the gas passage portion, separated from each other, and corresponding to respective regions of the gas passage portion; inlet opening-degree adjusting means are provided in the inlet manifolds, respectively; and the scavenging means controls the inlet opening-degree adjusting means so as to narrow down the inlet manifold or manifolds facing the narrowed down outlet manifold or manifolds.

According to this structure, when the scavenging process is performed in the fuel cell stack having the plurality of inlet manifolds and the plurality of outlet manifolds, the outlet manifold or manifolds are narrowed down, and the inlet manifold or manifolds facing the same outlet manifold or manifolds across the gas passage portion are also narrowed down. As the area of the gas inlet of the gas passage portion is thus reduced, the flow rate at which the scavenging gas is delivered into the gas passage portion increases, and therefore the remaining moisture can be more effectively discharged to the outside.

The third aspect of the invention relates to the fuel cell system according to the first aspect of the invention wherein: the outlet manifold is a single outlet manifold; a plurality of elastic members is provided in the outlet manifold; form controlling means for expanding or contracting the elastic members is provided; and the scavenging means limits the area via which the scavenging gas is discharged from the gas passage portion to the outlet manifold by expanding at least one of the elastic members.

According to this structure, when the scavenging process is performed, at least one of the elastic members provided in the outlet manifold is expanded, and as the elastic member is expanded in the outlet manifold, the outlet of the gas passage portion to the outlet manifold is narrowed down, whereby the area to which the scavenging gas is discharged is effectively limited.

Further, the scavenging means sequentially may switch the elastic member to be expanded by the form controlling means from one to another.

According to this structure, when the scavenging process is performed, the elastic member to be expanded is sequentially switched from one to another, whereby the gas outlet of the gas passage portion is switched. Thus, the remaining gas can be effectively discharged from the respective regions of the gas passage portion.

The fuel cell systems of the first aspect, the second aspect, and the third aspect of the invention may be such that the reaction gas is an oxidizing gas.

In this case, the scavenging process can be effectively performed to the cathode of each fuel cell.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a view schematically showing the configuration of a fuel cell system according to the first example embodiment of the invention;

FIG. 2 is a view schematically showing the internal structure of the fuel cell stack 10 shown in FIG. 1 and its peripheral components as viewed in the direction in which the components of the fuel cell stack 10 are stacked;

FIG. 3 is a view showing the detail of a cross section cutting through a portion of the fuel cell stack 10 shown in FIG. 2 in the direction in which the components of the fuel cell stack 10 are stacked;

FIG. 4 is a view illustrating gas flows during the power generation of the fuel cell stack 10;

FIG. 5 is a view illustrating gas flows during the scavenging process of the fuel cell stack 10;

FIG. 6 is a table defining the control state of each open-close valve 64 of the first example embodiment of the invention;

FIG. 7 is a view schematically showing the internal structure of the fuel cell stack 80 of the second example embodiment of the invention and its peripheral components as viewed in the direction in which the components of the fuel cell stack 80 are stacked;

FIG. 8 is a view illustrating gas flows during the scavenging process in the fuel cell stack 80;

FIG. 9 is a view schematically showing the internal structure of the fuel cell stack 90 of the third example embodiment of the invention and its peripheral components as viewed in the direction in which the components of the fuel cell stack 90 are stacked; and

FIG. 10 is a view illustrating gas flows during the scavenging process in the fuel cell stack 90.

### DETAILED DESCRIPTION OF THE EMBODIMENTS

Hereinafter, example embodiments of the invention will be described with reference to the accompanying drawings. It is to be noted that, in the following, like elements and components in the respective example embodiments will be denoted by like reference numerals and the descriptions on such elements and components will not be repeated. Further, it is to be understood that the invention is not limited to any of the following example embodiments.

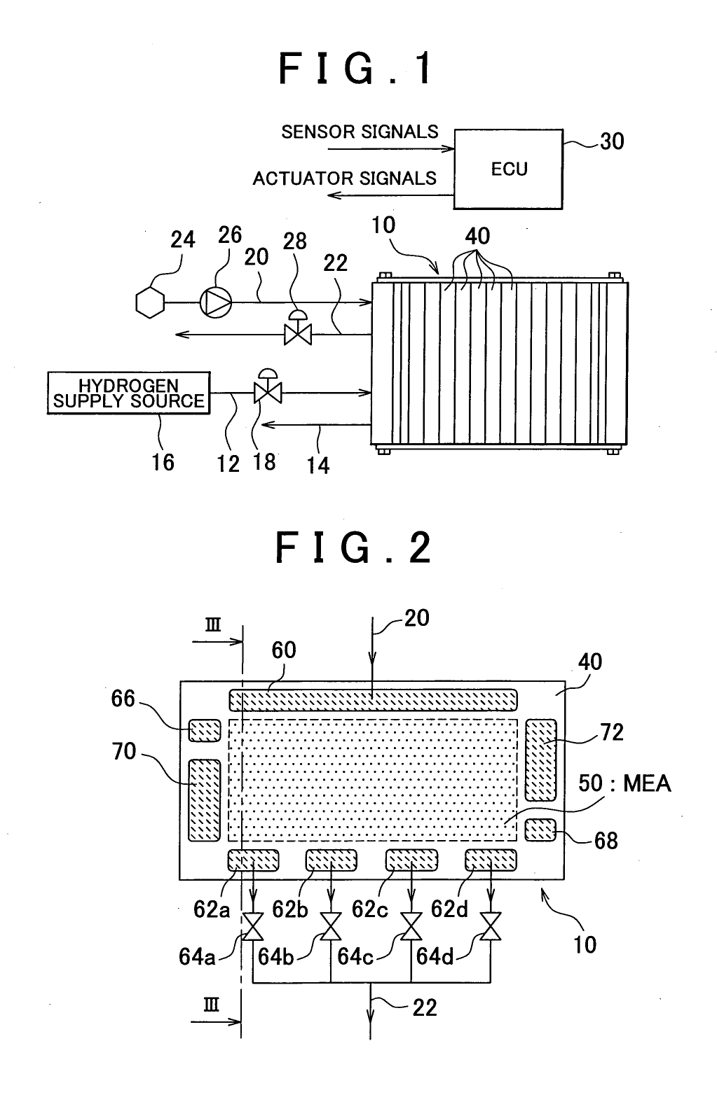

FIG. 1 is a view schematically showing the configuration of a fuel cell system according to the first example embodiment of the invention. Referring to FIG. 1, the fuel cell system of the first example embodiment is composed of a fuel cell stack 10. The fuel cell stack 10 is a solid polymer fuel cell stack having solid polymer separation membranes and it is typically used in a fuel cell vehicle, for example. The fuel cell stack 10 is constituted of a plurality of fuel cells 40 stacked on top of each other. Each fuel cell 40 is constituted of a proton-conductive electrolyte membrane, an anode provided on one side of the proton-conductive electrolyte membrane, a cathode provided on the other side of the proton-conductive electrolyte membrane, and two separators provided on the outer sides of the anode and the cathode, respectively. In the following, more detail on the structure of the fuel cell will be described.

An anode gas passage 12 for distributing anode gas (hydrogen) and an anode-off gas passage 14 are connected to the fuel cell stack 10. The upstream end of the anode gas passage 12 is connected to an anode gas supply source 16 (a high-pressure hydrogen tank, a reformer, and so on) and a pressure adjustment valve 18 is provided downstream of the anode gas supply source 16. The anode gas is depressurized to a desired pressure at the pressure adjustment valve 18 and then supplied to the fuel cell stack 10. After circulated through the fuel cell stack 10, the anode gas is discharged to the anode-off gas passage 14 as an anode-off gas. A diluter, which is not shown in the drawings, is provided in the downstream side of the anode-off gas passage 14. The hydrogen remaining in the anode-off gas is diluted to a sufficiently low concentration at the diluter and then discharged to the outside.

On the other hand, a cathode gas passage 20 for distributing a cathode gas (air) and a cathode-off gas passage 22 for discharging a cathode-off gas are connected to the fuel cell stack 10. At the inlet of the cathode gas passage 20 is provided an air cleaner 24 that is used to remove the dusts, and the like, contained in the air taken in from the outside. A compressor 26 is provided on the downstream side of the air cleaner 24. The air taken in through the operation of the compressor 26 is supplied to the fuel cell stack 10 via the cathode gas passage 20. A pressure adjustment valve 28 is provided in the cathode-off gas passage 22. The pressure adjustment valve 28 is capable of adjusting the pressure of the cathode gas in the fuel cell stack 10 to a desired pressure. After circulated through the fuel cell stack 10, the cathode gas is discharged to the cathode-off gas passage 22 as a cathode-off gas.

As is shown in FIG. 1, the fuel cell system of the first example embodiment is provided with an ECU (Electronic Control Unit) 30 that governs the overall control of the fuel cell system. The output portion of the ECU 30 is connected to the compressor 26, the pressure adjustment valves 18, 28, and various other components and devices, which are not shown in the drawings. On the other hand, the input portion of the ECU 30 is connected to various sensors, and the like, which are not shown in the drawings. The ECU 30 drives the respective components and devices by executing corresponding programs based on various information input from various sensors, and the like, which are connected to the ECU 30.

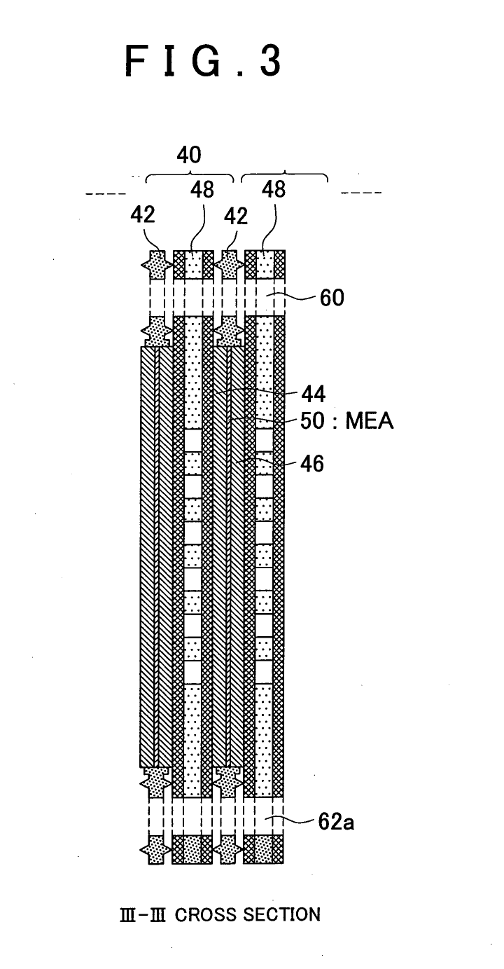

In the following, the structure of the fuel cell stack 10 of the first example embodiment and its peripheral components will be described with reference to FIG. 2 and FIG. 3. FIG. 2 is a view schematically showing the internal structure of the fuel cell stack 10 shown in FIG. 1 and its peripheral components as viewed in the direction in which the components of the fuel cell stack 10 are stacked. Referring to FIG. 2, an opening is formed at the upper side of each MEA 50 of the fuel cell stack 10, and said openings of the MEAs 50 together form an inlet manifold 60 for the cathode. The cathode gas passage 20 described above communicates with the inlet manifold 60.

On the other hand, openings of outlet manifolds 62a, 62b, 62c, and 62d for the cathode are formed at the lower side of each MEA 50 in the fuel cell stack 10. Note that the outlet manifolds 62a, 62b, 62c, and 62d will be collectively referred to as “the outlet manifolds 62” where one or more of them does not need to be distinguished from others. The cathode-off gas passage 22 communicates with the outlet manifolds 62a, 62b, 62c, and 62d, respectively. Further, open-close valves 64a, 64b, 64c, and 64d are provided in the cathode-off gas passage 22, in the vicinity of the connecting portion with the outlet manifolds 62. Note that the open-close valves 64a, 64b, 64c, and 64d will be collectively referred to as “the open-close valves 64” where one or more of them does not need to be distinguished from others. Further, an anode inlet manifold 66, an anode outlet manifold 68, a coolant inlet manifold 70, and a coolant outlet manifold 72 are formed in the fuel cell stack 10.

FIG. 3 is a view of a cross section cutting through a portion of the fuel cell stack 10 shown in FIG. 2 along the line III-III. Referring to FIG. 3, the fuel cell stack 10 has a stack structure constituted of a plurality of fuel cells 40 stacked on top of each other. Each fuel cell 40 is constituted of a power generation portion 42, a porous passage portion 44 through which the cathode gas flows, a porous passage portion 46 through which the anode gas flows, and separators 48 each serving as a partition between the adjacent power generation portions 42. The MEA 50 of each power generation portion 42 is constituted of an electrolyte membrane sandwiched by an anode and a cathode. Gas diffusion layers, which are not shown in the drawings, are formed on the outer sides of the MEA 50 and seal gaskets are integrally provided around the respective gas diffusion layers.

The porous passage portions 44 and 46 are made of foam, sintered metal, such as stainless steel, titanium, and titanium alloy, or of a porous material having many pores, such as a metal mesh. Because the porous passage portions 44 and 46 mainly serve as passages through which the respective reaction gases flow in given directions, the porous passage portions 44 and 46 are made of a porous material having a relatively high porosity in order to reduce the pressure loss against the flow of each reaction gas and thus improve the drainability. The porous passage portion 44 communicates with the inlet manifold 60 and the outlet manifold 62. The reaction gas is delivered into the porous passage portion 44 from the inlet manifold 60 and then passes through the pores of the porous passage portion 44 and reaches the cathode of the MEA 50. The off-gas produced as a result of the power generation reactions at the MEA 50 is discharged from the porous passage portion 44 to the outlet manifold 62. The porous passage portion 46 communicates with the anode inlet manifold 66 and the anode outlet manifold 68.

The separators 48 are a three-layer separator constituted of thin, conductive metal plates, such as stainless steel plates, titanium plates, and so on, which are stacked on top of each other. More specifically, each separator 48 is constituted of a cathode plate abutting on the porous passage portion 44, an anode plate abutting on the porous passage portion 46, and an intermediate plate interposed between the anode plate and the cathode plate.

Next, the operation of the fuel cell system of the first example embodiment will be described with reference to FIG. 4 to FIG. 6. The inside of the fuel cell stack 10 having the foregoing structure is kept moistened during the power generation of the fuel cell stack 10. More specifically, a sufficiently humidified reaction gas is delivered into the fuel cell stack 10, whereby moisture is carried into the fuel cell stack 10. Further, the water produced as a result of the power generation reactions also contributes to the humidification of the fuel cell stack 10.

The temperature of the fuel cell stack 10 is kept at approximately 80° C. during the power generation of the fuel cell stack 10, and therefore the moisture contained in the gas in the fuel cell stack 10 is condensed and dews are formed after the end of the power generation. If such water clogs up the passages in the fuel cell stack 10, the next start-up of the fuel cell stack 10 may become difficult (the system startability deteriorates). In addition, the moisture remaining in the fuel cell stack 10 is frozen when the power generation is stopped, for example, in a cold district where the ambient temperature is below zero, and therefore, the aforementioned clogging-up of the passages in the fuel cell stack 10 becomes more serious.

In view of the above, in the fuel cell system of the first example embodiment of the invention, when the power generation is stopped or when the power generation is not being performed, a scavenging process for discharging the moisture remaining in the fuel cell stack 10 is performed. More specifically, after the power generation at the fuel cell stack 10 ends, the compressor 26 provided on the cathode gas passage 20 is driven to send air, which serves as a scavenging gas, into the fuel cell stack 10 for a certain period of time. The scavenging gas delivered into the fuel cell stack 10 via the inlet manifold 60 flows through the porous passage portion 44 and then is discharged via the outlet manifold 62. During this time, the moisture stagnating in the fuel cell stack 10 is blown off by the scavenging gas and then discharged via the outlet manifold 62. As such, the moisture remaining in the passages of the cathode gas can be effectively discharged to the outside.

In order to achieve a high power generation efficiency in the fuel cell stack 10, it is desirable to ensure that power generation reactions evenly occur in respective regions of the MEA 50. Thus, in the fuel cell stack 10 of the first example embodiment, the gas inlet via which the reaction gas is delivered from the inlet manifold 60 to the porous passage portion 44 is large (e.g., more than 50% of the width of the inlet manifold 60). FIG. 4 is a view illustrating gas flows during the power generation of the fuel cell stack 10. As is shown in FIG. 4, because the gas passage width is large, the reaction gas can be evenly supplied to the respective regions of the MEA 50, so that a high power generation efficiency can be achieved at the fuel cell stack 10.

In the fuel cell stack 10 structured as described above, however, there is a possibility that the aforementioned scavenging process fail to be performed efficiently. That is, as mentioned earlier, during the scavenging process, the scavenging gas is circulated from the manifold inlet side to the manifold outlet side, so that the moisture remaining therebetween is effectively discharged to the outside. Therefore, in the case of a fuel cell stack in which the gas inlet of each MEA is large, the flow rate of the scavenging gas can be not made high enough to discharge the remaining moisture and therefore a desired scavenging effect can not be achieved.

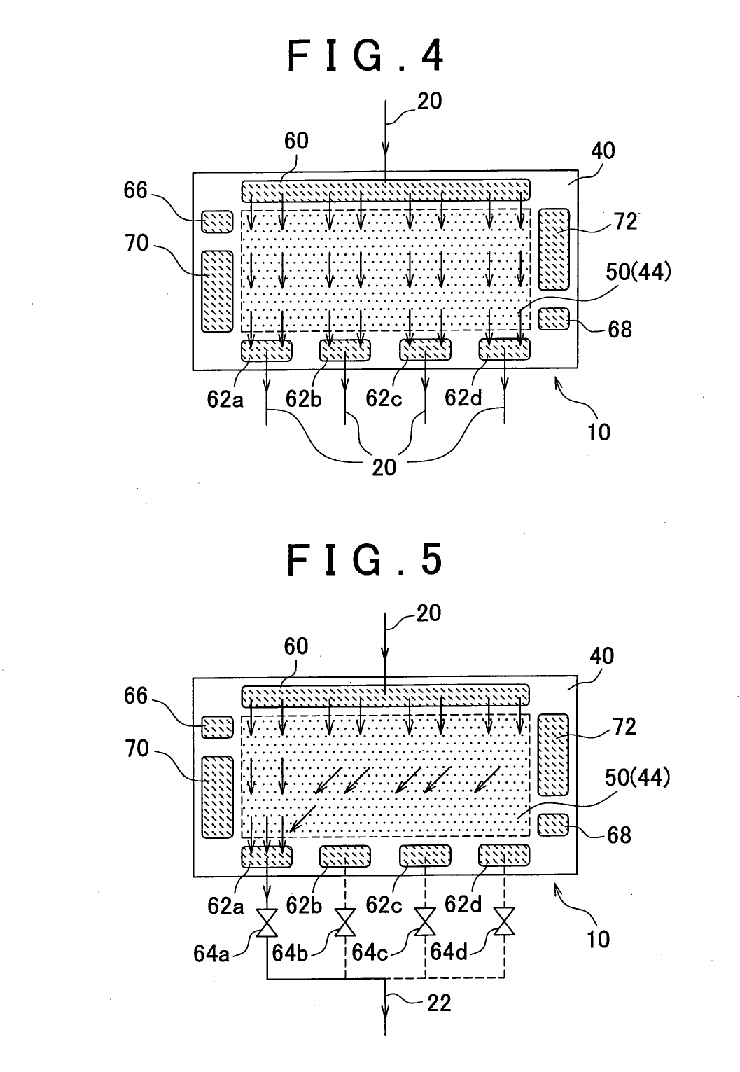

In view of the above, in the fuel cell system of the first example embodiment, the outlet of the scavenging gas is limited when the scavenging process is performed. FIG. 5 is a view illustrating gas flows during the scavenging process of the fuel cell stack 10. As is shown in FIG. 5, when the scavenging process is started, an open-close valve 64a is opened and open-close valves 64b, 64c, and 64d are closed, establishing a state where the scavenging gas can be discharged from the outlet manifold 62a only. Then, the scavenging gas is delivered into the fuel cell stack 10, so that it flows through the inside of the porous passage portion 44 and then all exits via the outlet manifold 62a. That is, at this time, because the outlet of the scavenging gas is limited to only one manifold, the scavenging gas flows through the inside of the porous passage portion 44 at an increased flow rate, and therefore the moisture remaining in the passages of the scavenging gas can be effectively discharged to the outside.

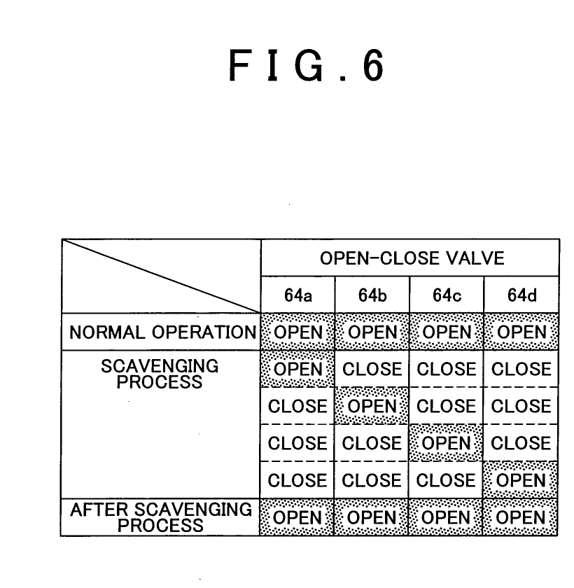

The flow path of the scavenging gas is switched from one to another at given time intervals. FIG. 6 is a table defining the control state of each open-close valve 64. The open-close valves 64 are opened and closed according to this table during the normal operation of the fuel cell stack 10 and during the scavenging process. More specifically, during the normal operation of the fuel cell stack 10, the open-close valves 64a, 64b, 64c, and 64d are all opened, so that the reaction gas delivered into the fuel cell stack 10 via the inlet manifold 60 is evenly supplied to the respective regions of the MEA 50.

On the other hand, when the power generation process of the fuel cell stack 10 is stopped, the scavenging process is started to remove the moisture remaining in the fuel cell stack 10. At this time, more specifically, the open-close valve 64a is first opened while the open-close valves 64b, 64c, and 64d are closed, whereby the moisture remaining in the vicinity of the outlet manifold 62a is effectively discharged to the outside. Then, the open-close valve 64b is opened while the open-close valves 64a, 64c, and 64d are closed, whereby the moisture remaining in the vicinity of the outlet manifold 62b is effectively discharged to the outside. Then, the open-close valve 64c is opened while the open-close valves 64a, 64b, and 64d are closed, whereby the moisture remaining in the vicinity of the outlet manifold 62c is effectively discharged to the outside. Finally, the open-close valve 64d is opened while the open-close valves 64a, 64b, and 64c are closed, whereby the moisture remaining in the vicinity of the outlet manifold 62d is effectively discharged to the outside.

According to the fuel cell system of the first example embodiment of the invention, as described above, when the scavenging process is performed, the outlet of the scavenging gas is limited so as to increase the flow rate of the scavenging gas flowing through the inside of the fuel cell stack 10, whereby the moisture remaining in the fuel cell stack 10 is effectively discharged to the outside.

According to the fuel cell system of the first example embodiment of the invention, further, because the outlet manifold via which the scavenging gas is discharged is switched from one to another at given time intervals, the fast scavenging gas flow can be created in each region. As such, the moisture remaining in the respective regions of the fuel cell stack 10 can be evenly discharged to the outside. Note that during the power generation of the fuel cell stack 10 all the outlet manifolds 62a, 62b, 62c, and 62d are opened and therefore the reaction gas is evenly supplied to the respective regions of the MEA 50, so that a high power generation efficiency is achieved.

While the moisture remaining in the cathode passages in the fuel cell stack 10 is discharged by performing the scavenging process in the first example embodiment, the passages to which the scavenging process is performed are not limited to said cathode passages. For example, the scavenging process may be performed to the anode passages in the fuel cell stack 10.

Further, while the open-close valves 64 are opened and closed according to the table shown in FIG. 6 in the first example embodiment, the open-close valves 64 may be controlled otherwise. For example, the open-close valves 64 may be more finely controlled in accordance with the amount of the moisture remaining in the fuel cell stack 10 and the distribution of said moisture, for example.

Further, while the fuel cell stack 10 has the porous passage portion 44 and the scavenging process is performed to discharge the moisture remaining in the porous passage portion 44 in the first example embodiment described above, the structure of the fuel cell stack 10 is not limited to this. For example, the reaction gas passages may be grooves instead of the porous portions.

Meanwhile, it is to be noted that the porous passage portion 44 in the first example embodiment described above may be regarded as corresponding to the “gas passage portion” of the invention.

Further, it is to be noted that the open-close valve 64 in the first example embodiment described above may be regarded as corresponding to the “outlet opening-degree adjusting means” of the invention.

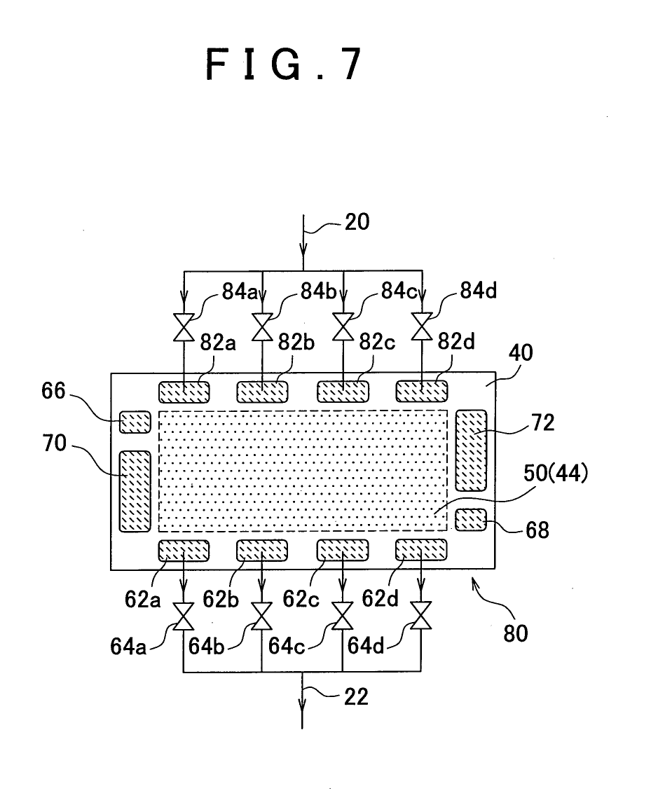

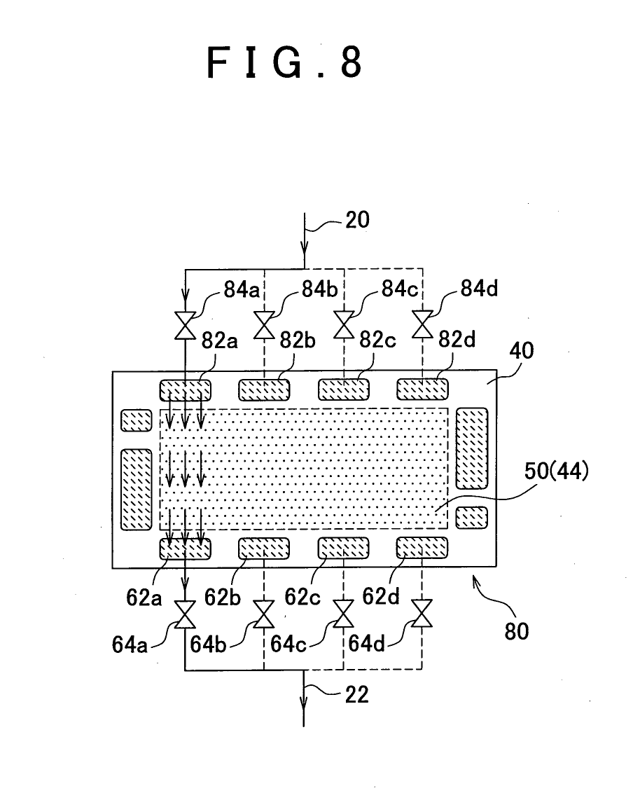

Next, the second example embodiment of the invention will be described with reference to FIG. 7 and FIG. 8. The fuel cell system of the second example embodiment is composed of a fuel cell stack 80 in place of the fuel cell stack 10 of the fuel cell system shown in FIG. 1. Note that the elements and components of the fuel cell system shown in FIG. 7 which are identical to those of the fuel cell system shown in FIG. 1 will be denoted by the same reference numerals and such elements and components will not be described again.

FIG. 7 is a view schematically showing the internal structure of the fuel cell stack 80 and its peripheral components as viewed in the direction in which the components of the fuel cell stack 80 are stacked. Referring to FIG. 7, openings are formed at the upper side of each MEA 50 of the fuel cell stack 80, and said openings of the MEAs 50 together form inlet manifolds 82a, 82b, 82c, and 82d for the cathode, respectively. Note that the inlet manifolds 82a, 82b, 82c, and 82d will be collectively referred to as “the inlet manifolds 82” where one or more of them does not need to be distinguished from others. The cathode gas passage 20 is branched and connected to the inlet manifolds 82a, 82b, 82c, and 82d, respectively. Open-close valves 84a, 84b, 84c, and 84d are provided immediately downstream of the branching point of the cathode gas passage 20. Note that the open-close valves 84a, 84b, 84c, and 84d will be collectively referred to as “the open-close valves 84” where one or more of them does not need to be distinguished from others.

Next, the operational features of the fuel cell system of the second example embodiment will be described with reference to FIG. 8. In the first example embodiment, as described in detail above, when the scavenging process is performed, the flow rate of the scavenging gas is increased by limiting the outlet of the scavenging gas to a specific one of the outlet manifolds, so that the moisture remaining in the fuel cell stack 10 is effectively discharged to the outside. On the other hand, in the second example embodiment, as well as the outlet of the scavenging gas, the inlet of the scavenging gas is limited so that the flow rate of the scavenging gas further increases.

FIG. 8 is a view illustrating gas flows during the scavenging process in the fuel cell stack 80. As is shown in FIG. 8, when the power generation of the fuel cell stack 80 is stopped and the scavenging process is started, the open-close valve 84a is opened while the open-close valves 84b, 84c, and 84d are closed, so that the scavenging gas can be delivered into the fuel cell stack 80 via the inlet manifolds 82a only. As such, the flow rate of the scavenging gas delivered to the porous passage portion 44 increases.

In the fuel cell system of the second example embodiment, further, the outlet of the scavenging gas is limited as shown in FIG. 8. More specifically, at this time, the open-close valve 64a is opened while the open-close valves 64b, 64c, and 64d are closed, establishing a state where the scavenging gas can be discharged only via the outlet manifold 62a located at a position corresponding to the inlet manifold 82a. As such, the scavenging gas delivered into the fuel cell stack 80 via the inlet manifold 82a is discharged via the outlet manifold 62a only.

In the case where the open-close valves 64 and 84 are controlled as described above, the flow rate of the scavenging gas increases more than it does in response to only the outlet of the scavenging gas being limited. Thus, the moisture remaining in the passages of the scavenging gas can be more effectively discharged to the outside.

The flow path of the scavenging gas is switched from one to another at given time intervals. More specifically, in the fuel cell system of the second example embodiment, the open-close valves 64, 84 are controlled according to the operation timing defined by the table shown in FIG. 6, and thus the flow path of the scavenging gas can be switched effectively.

According to the fuel cell system of the second example embodiment, as described above, when the scavenging process is performed, the flow rate of the scavenging gas flowing through the inside of the fuel cell stack 80 is effectively increased by limiting the inlet of the scavenging gas to a specific one of the inlet manifolds 82 as well as limiting the outlet of the scavenging gas to a specific one of the outlet manifolds 62. As such, the moisture remaining in the fuel cell stack 80 can be effectively discharged to the outside.

According to the fuel cell system of the second example embodiment, further, because the flow path of the scavenging gas is switched at given time intervals, the moisture remaining in the fuel cell stack 80 can be evenly discharged to the outside. Further, note that during the power generation of the fuel cell stack 80 the gas flow in each outlet manifold 62 is not limited and therefore the reaction gas is evenly supplied to the respective regions of the MEA 50, so that a high power generation efficiency is achieved.

While the moisture remaining in the cathode passages in the fuel cell stack 80 is discharged by performing the aforementioned scavenging process in the second example embodiment, the passages to which the scavenging process is performed are not limited to said cathode passages. For example, the scavenging process may be performed to the anode passages in the fuel cell stack 80.

Further, while the open-close valves 64, 84 are opened and closed according to the table shown in FIG. 6 in the second example embodiment, the open-close valves 64, 84 may be controlled otherwise. For example, the open-close valves 64, 84 may be more finely controlled in accordance with the amount of moisture remaining in the fuel cell stack 80 and the distribution of said moisture, for example.

Further, while the fuel cell stack 80 has the porous passage portion 44 and the scavenging process is performed to discharge the moisture remaining in the porous passage portion 44 in the second example embodiment described above, the structure of the fuel cell stack 80 is not limited to this. For example, the reaction gas passages may be grooves instead of the porous portions.

Meanwhile, it is to be noted that the open-close valve 84 of the fuel cell system of the second example embodiment may be regarded as corresponding to the “inlet opening-degree adjusting means” of the invention.

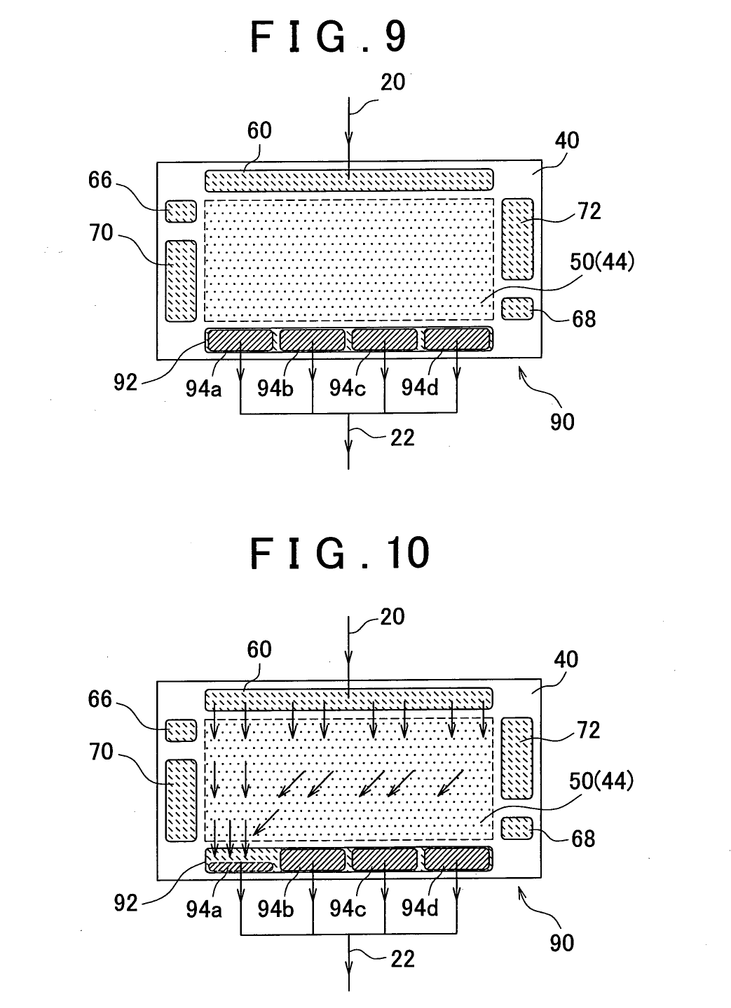

Next, the third example embodiment of the invention will be described with reference to FIG. 9 and FIG. 10. The fuel cell system of the third example embodiment is composed of a fuel cell stack 90 in place of the fuel cell stack 10 of the fuel cell system shown in FIG. 1. Note that the elements and components of the fuel cell system shown in FIG. 9 which are identical to those of the fuel cell system shown in FIG. 1 will be denoted by the same reference numerals and such elements and components will not be described again.

FIG. 9 is a view schematically showing the internal structure of the fuel cell stack 90 and its peripheral components as viewed in the direction in which the components of the fuel cell stack 90 are stacked. Referring to FIG. 9, an opening is formed at the lower side of each MEA 50 of the fuel cell stack 90, and said openings of the MEAs 50 together form an outlet manifold 92. The cathode off-gas passage 22 communicates with the outlet manifold 92. Elastic members 94a, 94b, 94c, and 94d are provided in the outlet manifold 92. Note that the elastic members 94a, 94b, 94c, and 94d will be collectively referred to as “the elastic members 94” where one or more of them does not need to be distinguished from others. Each elastic member 94 is an elastic member that is inflated when gas is supplied to the inside thereof. The elastic members 94 are made of a fluorine rubber or a silicon rubber. The elastic members 94 are connected to a compressor, which is not shown in the drawings, via pipes, which are not shown in the drawings, and pressure adjusting valves for the respective elastic members 94 are provided on the respective pipes. According to this structure, a selected one or more of the elastic members 94 can be inflated or deflated as needed.

Next, the operational features of the fuel cell system of the third example embodiment will be described with reference to FIG. 10. In the first example embodiment, as described in detail above, when the scavenging process is performed, the flow rate of the scavenging gas is increased by limiting the outlet of the scavenging gas to a specific one of the outlet manifolds, so that the moisture remaining in the fuel cell stack 10 is effectively discharged to the outside. On the other hand, in the third example embodiment, instead of said limitation of the scavenging gas outlet, the area of the outlet manifold 92 through which the scavenging is discharged is limited by inflating the elastic members 94 in the outlet manifold 92.

FIG. 10 is a view illustrating gas flows during the scavenging process in the fuel cell stack 90. As is shown in FIG. 10, when the scavenging process is started, the elastic member 94a is deflated while the elastic members 94b, 94c, and 94d are inflated, whereby the scavenging gas can be discharged only via the spaces near the elastic member 94a in the outlet manifold 92. That is, the area of the outlet manifold through which the scavenging gas is discharged is limited, so that the flow rate of the scavenging gas flowing through the inside of the porous passage portion 44 increases accordingly. As such, the moisture remaining in the passages of the scavenging gas can be effectively discharged to the outside.

The flow path of the scavenging gas is switched from one to another at given time intervals. More specifically, in the fuel cell system of the third example embodiment, the elastic members 94 are inflated and deflated according to the valve timing defined by the table of FIG. 6, so that the flow path of the scavenging gas is effectively switched from one to another in the fuel cell stack 90, and thus the moisture remaining in the fuel cell stack 80 can be effectively discharged to the outside.

According to the fuel cell system of the third example embodiment, as described above, when the scavenging process is performed, the flow rate of the scavenging gas flowing through the inside of the fuel cell stack 80 is effectively increased by limiting the area of the outlet manifold 92 through which the scavenging gas is discharged. As such, the moisture remaining in the fuel cell stack 80 can be effectively discharged to the outside. Further, because the elastic member 94 to be inflated is switched from one to another at given time intervals, the flow rate of the scavenging gas can be increased in each region, and therefore the moisture remaining in the respective regions of the fuel cell stack can be evenly discharged to the outside.

According to the fuel cell system of the third example embodiment, further, during the power generation of the fuel cell stack 80, all the elastic members 94 are deflated, so that the outlet manifold 92 serves as a single manifold extending along the outlet side face of each porous passage portion 44. As such, the gas inlet via which the gas flows from each porous passage portion 44 to the outlet manifold 92 is large, and therefore the reaction gas can be evenly supplied to the respective regions of the MEA 50, and thus a high power generation efficiency can be achieved.

While the moisture remaining in the cathode passages in the fuel cell stack 90 is discharged by performing the aforementioned scavenging process in the third example embodiment, the passages to which the scavenging process is performed are not limited to said cathode passages. For example, the scavenging process may be performed to the anode passages in the fuel cell stack 90.

Further, while the elastic members 94 are inflated and deflated according to the table shown in FIG. 6 in the third example embodiment, the states of the respective elastic members 94 may be controlled otherwise. For example, the states of the respective elastic members 94 may be more finely controlled in accordance with the amount of moisture remaining in the fuel cell stack 90 and the distribution of said moisture, for example.

Further, while the fuel cell stack 90 has the porous passage portion 44 and the scavenging process is performed to discharge the moisture remaining in the porous passage portion 44 in the third example embodiment described above, the structure of the fuel cell stack 90 is not limited to this. For example, the reaction gas passages may be grooves instead of the porous portions. Further, the elastic members 94 may have any structure and the state of each elastic member 94 may be controlled in any manner as long as the outlet manifold 92 can be narrowed down as needed.

Further, in the fuel cell system of the third example embodiment, as described above, the elastic members 94 are arranged in the outlet manifold 92 and used to limit the area of the outlet manifold 92 through which the scavenging gas is discharged. Alternatively, the elastic members 94 may be arranged at other positions. For example, the elastic members 94 may be arranged in the inlet manifold 60 and used to control the area of the inlet manifold through which the scavenging gas is delivered.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A fuel cell system comprising:
a fuel cell stack constituted of a plurality of fuel cells stacked on top of each other and adapted to generate electric power using a reaction gas supplied, each of the fuel cells having a gas passage portion through which the reaction gas flows and an outlet manifold to which the reaction gas is discharged from the gas passage portion;
a scavenging portion that circulates a scavenging gas from the gas passage portion to the outlet manifold;
a controlling portion that operates the scavenging portion when power generation of the fuel cell stack is stopped or when power generation of the fuel cell stack is not being performed; and
a plurality of opening-degree adjusting portions that adjust an opening degree of the outlet manifold,
wherein
the controlling portion opens all the opening-degree adjusting portions when power generation of the fuel cell stack is being performed, and closes part of the opening-degree adjustment portions when scavenging is being performed.

2. The fuel cell system according to claim 1, wherein:
the outlet manifold includes a plurality of outlet manifolds separated from each other and corresponding to respective regions of the gas passage portion;
the opening-degree adjusting portions are provided in at least one of the outlet manifolds; and
the controlling portion controls the opening-degree adjusting portions so as to narrow down the at least one of the outlet manifolds.

3. The fuel cell system according to claim 2, wherein:
the opening-degree adjusting portions are provided in the outlet manifolds, respectively; and
the controlling portion controls the opening-degree adjusting portions so as to narrow down at least one of the outlet manifolds.

4. The fuel cell system according to claim 3, wherein:
the controlling portion controls the opening-degree adjusting portions so as to narrow down all but one of the outlet manifolds at a time; and
the controlling portion sequentially switches the outlet manifold to be not narrowed down by the opening-degree adjusting portions from one to another.

5. The fuel cell system according to claim 2, wherein:
each of the fuel cells has a plurality of inlet manifolds connected to the gas passage portion, separated from each other, and corresponding to respective regions of the gas passage portion;
the fuel cell system further comprises inlet opening-degree adjusting portion provided in the inlet manifolds, respectively, for adjusting an opening degree of the inlet manifolds; and
the controlling portion controls the inlet opening-degree adjusting means portions so as to narrow down the inlet manifold or manifolds located at a position facing the narrowed down outlet manifold or manifolds.

6. The fuel cell system according to claim 1, wherein:
the outlet manifold is a single outlet manifold;
the opening-degree adjusting portions are a plurality of expandable and contractible elastic members provided in the outlet manifold; and
the controlling portion narrows down the outlet manifold by expanding at least one of the elastic members.

7. The fuel cell system according to claim 6, wherein:
the controlling portion expands all but one of the elastic members at a time; and
the controlling portion sequentially switches the elastic member to be not expanded from one to another.

8. The fuel cell system according to claim 1, wherein the reaction gas is an oxidizing gas.

9. A scavenging process for discharging moisture remaining in a fuel cell system comprising
a fuel cell stack constituted of a plurality of fuel cells stacked on top of each other and adapted to generate electric power using a reaction gas supplied, each of the fuel cells having a gas passage portion through which the reaction gas flows and an outlet manifold to which the reaction gas is discharged from the gas passage portion,
said scavenging process comprising:
supplying a scavenging gas from the gas passage portion to the outlet manifold when power generation of the fuel cell stack is stopped or when power generation of the fuel cell stack is not being performed; and
limiting an area via which the scavenging gas is discharged from the gas passage portion.
